(19) United States
(12) Patent Application Publication
(10) Pub. No.: US 2021/0171401 A1
(43) Pub. Date: Jun. 10, 2021

(54) MONOLITHIC POROUS BODY COMPRISING MAGNELI PHASE TITANIUM OXIDE AND METHOD OF MAKING THE POROUS BODY

(71) Applicant: SAINT-GOBAIN CERAMICS & PLASTICS, INC., Worcester, MA (US)

(72) Inventors: Francesca MIRRI, Acton, MA (US); Stéphane RAFFY, Cavaillon (FR); Michael McGAHAN, Middletown, RI (US); Corinne SALLES, Caumont Sur Durance (FR); Jean-Marie LEBRUN, Allston, MA (US); Paul W. REHRIG, Sterling, MA (US)

(21) Appl. No.: 17/118,065

(22) Filed: Dec. 10, 2020

Related U.S. Application Data
(60) Provisional application No. 62/946,367, filed on Dec. 10, 2019.

(51) Int. Cl. C04B 35/46; C02F 1/469; C02F 1/461; C04B 35/634; C04B 35/64; C04B 38/00; C04B 38/06

(52) U.S. Cl. CPC C04B 35/46; C02F 1/4691; C02F 1/46109; C04B 35/63416; C04B 35/63456; C04B 35/64; C02F 2101/30; C04B 38/0054; C04B 38/0615; C04B 2235/3237; C04B 2235/5436; C04B 2235/96; C02F 2001/46161; C04B 38/0074

(57) ABSTRACT

A monolithic porous body can comprise magneli phase titanium oxide and a developed interfacial area ratio Sdr of at least 60%. The monolithic body can further comprise a total porosity of at least 25% based on the total volume of the body. The monolithic porous body can have a high efficiency for the degradation of water pollutants if used as anode material in an electrolytic cell.

### CROSS-REFERENCE TO RELATED APPLICATION

This application claims priority under 35 U.S.C. § 119(e) to U.S. Provisional Application No. 62/946,367, entitled “MONOLITHIC POROUS BODY COMPRISING MAGNELI PHASE TITANIUM OXIDE AND METHOD OF MAKING THE POROUS BODY,” by Francesca MIRRI, et al., filed Dec. 10, 2019, which is assigned to the current assignee hereof and is incorporated herein by reference in its entirety.

### FIELD OF THE DISCLOSURE

The present disclosure relates to a monolithic porous body comprising magneli phase titanium oxide and a method of making the monolithic porous body.

### BACKGROUND

Ceramic materials made of magneli phase titanium oxide (TiₙO₂ₙ₋₁) are known as anode materials for the electrochemical degradation of micro-pollutants in water, for example, in electrochemical advanced oxidation processes (AOP). A disadvantage of these anode materials is that they are very sensitive to fouling and clogging of the pores on the surface.

There exists a need to further improve electrode materials.

### BRIEF DESCRIPTION OF THE DRAWINGS

The present disclosure may be better understood, and its numerous features and advantages made apparent to those skilled in the art by referencing the accompanying drawings.

FIG. 1 includes a scheme illustrating a method of making a monolithic porous TiOx body according to one embodiment.

FIG. 2A includes a drawing illustrating the monolithic porous body according to one embodiment.

FIG. 2B includes a drawing illustrating the monolithic porous body according to one embodiment.

FIG. 2C includes a drawing illustrating the monolithic porous body according to one embodiment.

FIG. 2D includes a drawing illustrating the monolithic porous body according to one embodiment.

FIG. 3A includes an image showing a monolithic porous body according to one embodiment.

FIG. 3B includes an SEM image of a portion of the body shown in FIG. 2A with a 30 times magnification according to one embodiment.

FIG. 3C includes an SEM image of a portion of the body shown in FIG. 2A with a 1000 times magnification according to one embodiment.

FIG. 4A includes an optical microscope image of comparative body C1.

FIG. 4B includes an SEM image of a portion of the comparative body shown in FIG. 4A with a 30 times magnification.

FIG. 4C includes an SEM image of a section of a portion of the comparative body shown in FIG. 4A with a 1000 times magnification.

FIG. 5 includes an illustration of the measuring principle of the developed interfacial area ratio Sdr.

FIG. 6 includes a graph illustrating the electrochemical degradation of acetaminophen with time according to one embodiment.

FIG. 7 includes a graph illustrating the specific energy consumption with time during electrochemical degradation of acetaminophen according to one embodiment.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to a monolithic porous body comprising magneli phase titanium oxide. In one aspect, the monolithic ceramic body can have a high developed interfacial surface area Sdr. In another aspect, the body may have a high efficiency if used as an anode material for electrochemically degrading micro-pollutants in water.

As used herein, the term magneli phase titanium oxide relates to titanium oxide with the summary formula TiₙO₂ₙ₋₁, wherein n can be a number between 4 and 7, such as Ti₄O₇, Ti₅O₉, Ti₆O₁₁, or Ti₇O₁₃. As further used herein, the term magneli phase titanium oxide is interchangeable with the terms “magneli phase TiₙO₂ₙ₋₁” or “magneli phase TiOₓ.”

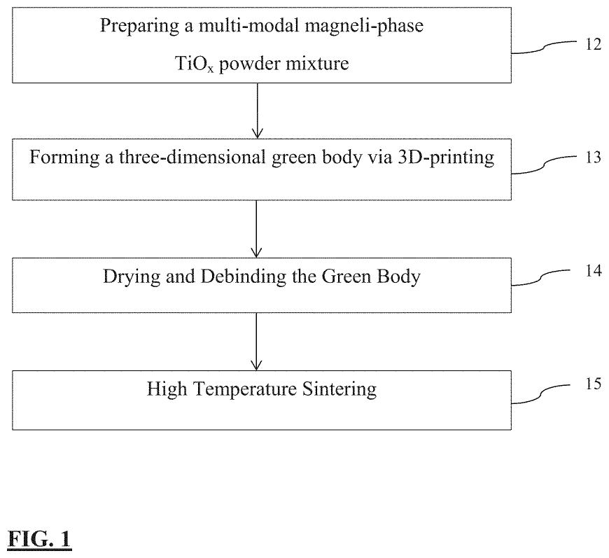

In one embodiment, the monolithic porous body comprising magneli phase TiOₓ of the present disclosure can be made by an additive manufacturing process, also called herein three-dimensional (3D) printing of a green body. In one particular embodiment, as illustrated in FIG. 1, the method can include: preparing a multi-modal magneli phase TiOₓ powder mixture (12); forming a three-dimensional green body via 3D printing (13); drying and debinding the green body (14); and high temperature sintering (15).

In one aspect, the multi-modal magneli phase TiOx powder mixture of the first step (12) of the method can include a bi-modal particle distribution. The bi-modal particle distribution may comprise a first plurality of particles with an average particle size (D50) of at least 1 μm and not greater than 10 μm, and a second plurality of particles with an average particle size (D50) of at least 20 μm and not greater than 50 μm.

In another aspect, a weight % ratio of the first plurality of particles to the second plurality of particles can be from 1:0.1 to 1:10. In certain aspects, the weight % ratio can be not greater than 1:0.3, or not greater than 1:0.5, or not greater than 1:1, or not greater than 1:2, or not greater than 1:3, or not greater than 1:4, or not greater than 1:5, or not greater than 1:6, or not greater than 1:7, or not greater than 1:8, or not greater than 1:9, or not greater than 1:10.

In a further embodiment, the aspect ratio of major length to major height of the particles of the TiOx powder mixture can be 1, or at least 1.2, or at least 1.4, or at least 1.6. or at least 1.8, or at least 2. In another aspect, the aspect ratio may be not greater than 10, or not greater than 5, or not greater than 3 or not greater than 2. In a certain particular aspect, the aspect ratio can be at least 1.5 and not greater than 3.

In yet another aspect, the roundness of the particles of the TiOx powder mixture can be 1, or not greater than 0.9 or not greater than 0.8, or not greater than 0.7, or not greater than 0.6. In a certain particular aspect, the roundness of the particles may be not greater than 0.7.

The magneli-phase titanium oxide particles used as starting material may not be limited to a bi-modal particle distribution, and can also include, for example, a three-modal or a four-modal particle distribution containing fine and coarse particles.

Referring again to FIG. 1, in one embodiment, a green body can be formed by 3D printing (13). In a particular aspect, the 3D printing can be conducted by binder jetting, wherein a green body is formed via layer by layer depositing of the magneli phase powder mixture, adding a binder at defined areas on top of the powder mixture, and at least partially curing the binder before applying the next layer.

After forming of the green body, the green body can be dried and subjected to debinding to remove the binder (14). In one aspect, debinding can be conducted under air at a temperature that decomposes the binder. Depending on the type of binder, the debinding temperature can be between 300° C. and 600° C.

After the debinding (14), the body can be further subjected to high temperature sintering (15). In one aspect, the high temperature sintering can be conducted up to a maximum temperature of at least 1300° C., or at least 1350° C., or at least 1400° C., or at least 1450° C., or at least 1500° C. In a certain aspect, the sintering can be conducted in a non-oxidizing atmosphere, for example, under argon gas.

In another aspect, debinding can also be conducted in a non-oxidizing atmosphere, like the high temperature sintering, while heating the body up for high temperature sintering.

The method of the present disclosure can produce magneli phase TiOₓ bodies with certain features or combination of features as disclosed in embodiments herein.

In one embodiment, the monolithic porous body comprising magneli phase TiOₓ can have a developed interfacial area ratio Sdr of at least 60%, such as at least 70%, or at least 100%, or at least 120%, or at least 140%, or at least 160%, or at least 180%. In another embodiment, the Sdr can be not greater than 15,000%, or not greater than 10,000%, or not greater than 5,000%, or not greater than 1,000%, or not greater than 500%, or not greater than 300%, or not greater than 200%. It will be appreciated that the Sdr can be a value within a range between any of the minimum and maximum values noted above.

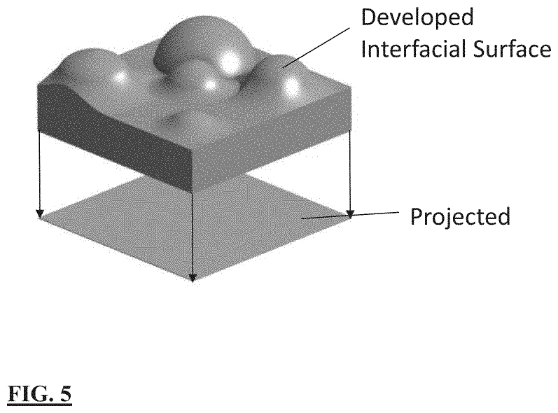

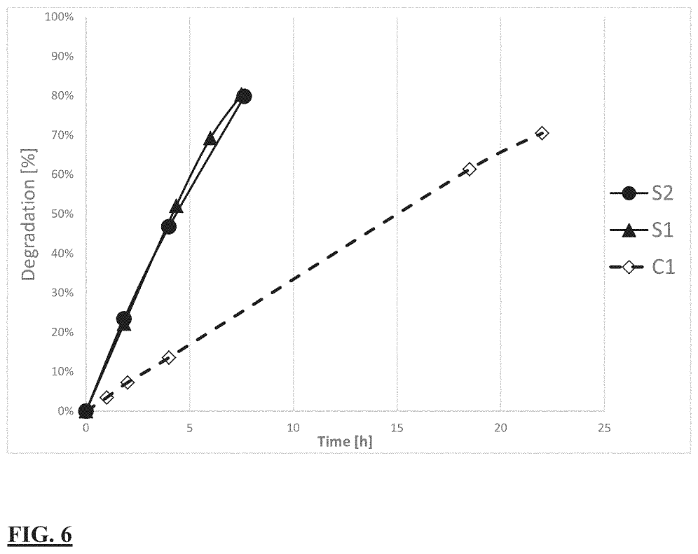

The developed interfacial area ratio Sdr expresses the increase in surface area A₁ (provided by the surface texture) in relation to a corresponding underlying projected area A₀, and was measured according to ISO standard method ISO25178-2:2012, as also illustrated in FIG. 5.

In another embodiment, the body of the present disclosure can further have a high porosity with a pore size distribution over a large pore size range.

In one aspect, the total porosity of the body can be at least 25 vol % based on the total volume of the body, or at least 30 vol %, or at least 35 vol %, or at least 40 vol %, or at least 45 vol %, or at least 50 vol %, or at least 55 vol %, or at least 60 vol %, or at least 65 vol %, or at least 70 vol %, or at least 75 vol %, or at least 80 vol %. In another aspect, the total porosity of the magneli phase TiOₓ body can be not greater than 99 vol %, or not greater than 95 vol %, or not greater than 90 vol %, or not greater than 85 vol %, or not greater than 80 vol %, or not greater than 75 vol %, or not greater than 60 vol % based on the total volume of the body. Moreover, the total porosity can be a value within a range between any of the minimum and maximum values noted above.

In a certain aspect, the body can contain pores having a diameter from 2 μm to 10 μm in an amount of at least 15 vol % based on the total volume of the body, such as at least 18 vol %, at least 20 vol %, at least 25 vol %, or at least 30 vol %. In another aspect, the amount of pores having a diameter from 2 μm to 10 μm may be not greater than 60 vol %, or not greater than 50 vol %, or not greater than 40 vol %, or not greater than 35 vol %.

In another aspect, the body can contain pores having a diameter from 10 μm to 20 μm in an amount of at least 2 vol %, or at least 3 vol %, or at least 4 vol %, or at least 5 vol % based on the total volume of the body. In a further aspect, the amount of pores having a diameter from 10 μm to 20 μm may be not greater than 50 vol %, or not greater than 40 vol %, or not greater than 30 vol %, or not greater than 30 vol %, or not greater than 20 vol %, or not greater than 10 vol %, or not greater than 7 vol %, or not greater than 5 vol %.

In a further aspect, the body can contain pores having a diameter from 20 μm to 100 μm in an amount of at least 3 vol %, or at least 4 vol %, or at least 5 vol %, or at least 6 vol % based on the total volume of the body. In another aspect, the amount of pores having a diameter from 20 μm to 100 μm may be not greater than 40 vol %, or nor greater than 30 vol %, or not greater than 20 vol %, or not greater than 15 vol %, or not greater than 10 vol %, or not greater than 8 vol %, or not greater than 5 vol %.

In yet a further aspect, the body may have pores having a diameter from 100 μm to 345 μm in an amount of at least at least 2 vol %, or at least 4 vol %, or at least 5 vol %, or at least 6 vol %, or at least 7 vol %, or at least 10 vol %, or at least 15 vol %, or at least 20 vol % based on the total volume of the body. In another aspect, the pores having a diameter from 100 μm to 345 μm may be not greater than 95 vol %, or not greater than 90 vol %, or not greater than 80 vol %, or not greater than 70 vol %, or not greater than 60 vol %, or not greater than 50 vol %, or not greater than 40 vol %, or not greater than 20 vol %, or not greater than 10 vol %, or not greater than 8 vol %.

In another aspect, the body can comprise pores having a diameter of up to 2 μm in an amount of not greater than 2 vol % based on the total volume of the body, or not greater than 1 vol %.

In one embodiment, the combined amount of the pores up to a size of 345 μm in the body can be at least 25 vol %, or at least 30 vol %, or at least 35 vol %, or at least 40 vol %, or at least 45 vol % based on the total volume of the body. In another aspect, the amount of pores up to a size of 345 μm may be not greater than 95 vol %, such as not greater than 90 vol %, not greater than 80 vol %, or not greater than 70 vol %, or not greater than 60 vol %, or not greater than 55 vol %, or not greater than 50 vol %, or not greater than 45 vol %, or not greater than 40 vol % based on the total volume of the body. Moreover, the amount of pores up to a size of 345 μm can be a value within a range including any of the minimum and maximum values noted above.

In a further embodiment, the amount of pores having a size greater than 345 μm, up to about 2000 μm, herein also called “macro-pores,” can be at least 2 vol % based on the total volume of the body, or at least 5 vol %, or at least 10 vol %, or at least 15 vol %, or at least 20 vol %, or at least 25 vol %, or at least 30 vol %, or at least 40 vol %, or at least 50 vol %. In another aspect, the amount of macro-pores may be not greater than 95 vol %, or not greater than 90 vol %, or not greater than 80 vol %, or not greater than 70 vol %, or not greater than 60 vol %, or not greater than 50 vol %, or not greater than 45 vol %, or not greater than 40 vol %, or not greater than 35 vol %, or not greater than 30 vol %, or not greater than 20 vol %, or not greater than 10 vol %, or not greater than 5 vol % based on the total volume of the body. Moreover, the amount of macro-pores can be a value within a range including any of the minimum and maximum values note above.

In a particular aspect, the magneli phase TiOx body of the present disclosure can have an Sdr of at least 100% and a total porosity of at least 30%. In another particular aspect, the Sdr can be at least 150% and the total porosity may be at least 50%. In yet a further particular aspect, the Sdr can be at least 170% and the total porosity may be at least 70% based on the total volume of the body.

The monolithic porous magneli phase TiOx body of the present disclosure can contain one or more magneli phases, such as Ti₄O₇, Ti₅O₉, Ti₆O₁₁, Ti₇O₁₃, or any combination thereof.

In one embodiment, the monolithic porous body can comprise Ti₄O₇ in an amount of at least at least 5 wt % based on the total weight of the body, such as at least 7 wt %, or at least 10 wt %, or at least 12 wt %, or at least 15 wt %, or at least 20 wt %, or at least 30 wt %, or at least 40 wt %, or at least 50 wt %, or at least 70 wt %, or at least 90 wt %, or 100 wt %. In another embodiment, the body can contain Ti₄O₇ in an amount not greater than 99 wt % based on the total weight of the body, such as not greater than 95 wt %, or not greater than 90 wt %, or not greater than 80 wt %, or not greater than 70 wt %, or not greater than 60 wt %, or not greater than 50 wt %, or not greater than 30 wt %, or not greater than 25 wt %, or not greater than 20 wt %, or not greater than 15 wt %. Moreover, the amount of the Ti₄O₇ in the body can be a value within a range including any of the minimum and maximum values noted above.

In another embodiment, the monolithic porous body can comprise Ti₅O₉ in an amount of at least 10 wt % based on the total weight of the body, such as at least 20 wt %, or at least 30 wt %, or at least 50 wt %, or at least 55 wt %, or at least 60 wt %, or at least 65 wt %, or at least 70 wt %, or at least 75 wt %. In yet another embodiment, the amount of Ti₅O₉ magneli phase in the body can be not greater than 85 wt % based on the total weight of the body, such as not greater than 85 wt %, or not greater than 80 wt %, or not greater than 70 wt %, or not greater than 60 wt %, or not greater than 50 wt %. Moreover, the amount of Ti₅O₉ in the body can be a value within a range including any of the minimum and maximum values noted above.

In a further embodiment, the monolithic porous body of the present disclosure can include Ti₆O₁₁ in an amount of at least 1 wt % based on the total weight of the body, or at least 2 wt %, or at least 5 wt %, or at least 7 wt %, or at least 9 wt %. In another embodiment, the body can contain Ti₆O₁₁ in an amount not greater than 20 wt % based on the total weight of the body, not greater than 15 wt %, or not greater than 10 wt %. Moreover, the amount of Ti₆O₁₁ can be a value within a range including any of the minimum and maximum values noted above. In another particular aspect, the body can be also free of Ti₆O₁₁.

In one non-limiting embodiment, the monolithic porous body of the present disclosure can include at least 10 wt % Ti₄O₇, at least 50 wt % Ti₅O₉, at least 4 wt % Ti₆O₁₁, and at least 1 wt % Ti₇O₁₃.

In another aspect, the monolithic porous body can consist essentially of Ti₄O₇ and Ti₅O₉, except for unavoidable impurities.

In a further aspect, the monolithic porous body can consist essentially of Ti₄O₇, except for unavoidable impurities.

In yet another aspect, the monolithic porous body may consist essentially of Ti₅O₉, except for unavoidable impurities.

The monolithic porous magneli phase TiOₓ body of the present disclosure can have a conductivity of at least 20 S/cm, or at least 25 S/cm, or at least 30 S/cm, or at least 50 S/cm, or at least 70 S/cm, or at least 100 S/cm.

In a further aspect, the porous magneli phase TiOₓ body can comprise a flexural strength of at least 0.05 MPa, such as at least 0.1 MPa, or at least 0.2 MPa, or at least 0.5 MPa, or at least 1 MPa, or at least 3 MPa, or at least 5 MPa, or at least 10 MPa, or at least 15 MPa, or at least 20 MPa. The flexural strength may be measured according to ASTM C1161-18.

In another embodiment, the magneli phase TiOₓ body of the present disclosure can be very efficient in the electrochemical degradation of micro-pollutants if used as anode material.

In a certain instance, the body of the present disclosure can have a water pollutant degradation of at least 25%. As used herein, the term “water pollutant degradation” is defined as the electrochemical degradation of acetaminophen contained in an aqueous fluid after 4 hours, wherein the electrochemical degradation is conducted in an electrolytic cell at a current density of 5 mA/cm², the aqueous fluid includes acetaminophen in an amount of 0.16 kg/m³, Na₂SO₄ in an amount of 7.1 kg/m³, and distilled water, and a volume of the aqueous fluid is 500 cm³; the monolithic porous body is positioned as an anode with a size of 60 mm×30 mm between two titanium cathodes, each cathode having at least the same size as the anode, a distance between the anode and each cathode is 15 mm, and a temperature of the aqueous acetaminophen solution is 30° C. The percent degradation of the acetaminophen as used herein expresses the decrease (elimination) in the total organic carbon content (TOC) of the acetaminophen.

In one aspect, the water pollutant degradation of the body can be at least 30%, or at least 35%, or at least 40%, or at least 45%, or at least 50%, or at least 55%.

The degradation of acetaminophen described herein has the function of a test for defining the efficiency of the anode material. The body of the present disclosure may not be limited to the degradation of acetaminophen, but can be used for the electrochemical degradation of any other oxidizable water pollutant. In one aspect, the degradation of a water pollutant can be a complete mineralization of a pollutant. In another aspect, the degradation of a water pollutant can include just a minor change (oxidation) in the molecule structure of the water pollutant, and the pollutant may be still an organic molecule after the degradation reaction.

In addition to a high efficiency for the degradation of water pollutants, the body of the present disclosure can further have the advantage of a low specific energy consumption during the electrochemical degradation. In one embodiment, a specific energy consumption for the water pollutant degradation of the above defined electrochemical degradation of acetaminophen between 1 to 10 hours can be not greater than 600 kWh per kg total organic carbon (kWh/kg TOC), such as not greater than 500 kWh/kg TOC, or not greater than 400 kWh/kg TOC, or not greater than 350 kWh/kg TOC, or not greater than 300 kWh/kg TOC, with TOC being the total organic carbon content of the acetaminophen. As used herein, the specific energy consumption expressed by the unit “kWh/kg TOC” relates to kg eliminated TOC during the acetaminophen degradation.

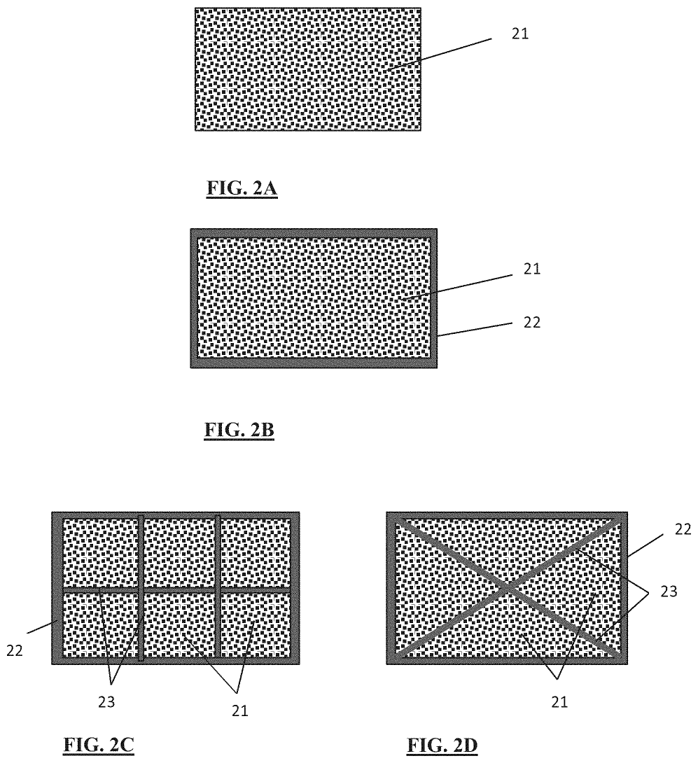

In one embodiment, the monolithic ceramic body of the present disclosure can further include a frame structure for protecting and easier handling of the body. FIG. 2A illustrates an embodiment of a body having a highly porous structure (21) without frame, while FIG. 2B shows an embodiment including a frame structure (22) surrounding the highly porous center region which form a center region (21). Frame structure (22) and center region (21) can be both part of the same monolithic body and printed from the same material comprising magneli phase TiOx particles.

In one aspect, as illustrated in FIGS. 2C and 2D, the monolithic ceramic body can further contain a reinforcement structure (23). The reinforcement structure (23) can divide the highly porous center region in a plurality of sections (21), which may be further stabilized by the frame structure (22).

In another aspect, an intermediate structure (not shown) can be included between the frame structure (22) and the highly porous center region (21), wherein the intermediate structure may have a density gradient with the density decreasing in the direction from the frame structure to the highly porous center region.

In a further embodiment, the monolithic porous body of the present disclosure can have the shape of a tube. In one aspect, the tube can be designed to allow water to flow through the tube and to degrade electrochemically a pollutant contained in the water which comes in contact with the conductive surface of the tube when electrically connected to a cathode.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

A monolithic porous body comprising magneli phase titanium oxide and a developed interfacial area ratio Sdr of at least 60%, the Sdr being measured according to ISO25178-2:2012.

### Embodiment 2

A monolithic porous body comprising magneli phase titanium oxide and having a water pollutant degradation of at least 25%.

### Embodiment 3

The monolithic porous body of Embodiments 1 or 2, wherein a specific energy consumption for conducting a water pollutant degradation is not greater than 600 kWh/kg TOC, or not greater than 500 kWh/kg TOC, or not greater than 400 kWh/kg TOC, or not greater than 350 kWh/kg TOC, or not greater than 300 kWh/kg TOC between 1 and 10 hours.

### Embodiment 4

The monolithic porous body of Embodiments 2 or 3, wherein the body comprises a developed interfacial area ratio Sdr of at least 60%, the Sdr being measured according to ISO25178-2:2012.

### Embodiment 5

The monolithic porous body of Embodiments 1 or 4, wherein the developed interfacial area ratio Sdr of the body is at least 70%, or at least 100%, or at least 120%, or at least 140%, or at least 160%, or at least 180%.

### Embodiment 6

The monolithic porous body of Embodiment 2, wherein the water pollutant degradation is at least 30%, or at least 35%, or at least 40%, or at least 45%, or at least 50%, or at least 55%.

### Embodiment 7

The monolithic porous body of any one of the preceding Embodiments, wherein the body comprises a total porosity of at least 25% based on the total volume of the body, or at least 30%, or at least 35%, or at least 40%, or at least 45%, or at least 50%, or at least 60%, or at least 70%, or at least 80%.

### Embodiment 8

The monolithic porous body of any one of the preceding Embodiments, wherein the body comprises a total porosity of not greater than 99 vol %, or not greater than 95 vol %, or not greater than 90 vol %, or not greater than 85 vol %, or not greater than 80 vol %, or not greater than 75 vol %, or not greater than 70 vol %, or not greater than 60 vol % based on the total volume of the body.

### Embodiment 9

The monolithic porous body of any one of the preceding Embodiments, wherein the body comprises pores having a diameter from 2 μm to 10 μm in an amount of at least 5 vol % based on the total volume of the body, such as at least 10 vol %, at least 15 vol %, at least 18 vol %, at least 20 vol %, at least 25 vol %, or at least 30 vol %.

### Embodiment 10

The monolithic porous body of any one of the preceding Embodiments, wherein the body comprises pores having a diameter from 2 μm to 10 μm in an amount of not greater than 60 vol %, or not greater than 60 vol %, or not greater than 50 vol %, or not greater than 40 vol %, or not greater than 35 vol %.

### Embodiment 11

The monolithic porous body of any one of the preceding Embodiments, wherein the body comprises pores having a diameter from 10 μm to 20 μm in an amount of at least 2 vol %, or at least 3 vol %, or at least 4 vol %, or at least 5 vol %, or at least 10 vol %, or at least 15 vol %, or at least 20 vol % based on the total volume of the body.

### Embodiment 12

The monolithic porous body of any one of the preceding Embodiments, wherein the body comprises pores having a diameter from 10 μm to 20 μm in an amount of not greater than 50 vol %, or not greater than 40 vol %, or not greater than 30 vol %, or not greater than 30 vol %, or not greater than 20 vol %, or not greater than 10 vol %, or not greater than 7 vol %, or not greater than 5 vol %

### Embodiment 13

The monolithic porous body of any one of the preceding Embodiments, wherein the body comprises pores having a diameter from 20 μm to 100 μm in an amount of at least 3 vol %, or at least 4 vol %, or at least 5 vol %, or at least 6 vol %, or at least 10 vol %, or at least 15 vol %, based on the total volume of the body.

### Embodiment 14

The monolithic porous body of any one of the preceding Embodiments, wherein the body comprises pores having a diameter from 20 μm to 100 μm in an amount not greater than 40 vol %, or nor greater than 30 vol %, or not greater than 20 vol %, or not greater than 15 vol %, or not greater than 10 vol %, or not greater than 8 vol %, or not greater than 5 vol %.

### Embodiment 15

The monolithic porous body of any one of the preceding Embodiments, wherein the body comprises pores having a diameter from 100 μm to 345 μm in an amount of at least 4 vol %, or at least 5 vol %, or at least 6 vol %, or at least 7 vol %, or at least 10 vol %, or at least 15 vol %, or at least 20 vol % based on the total volume of the body.

### Embodiment 16

The monolithic porous body of any one of the preceding Embodiments, wherein the body comprises pores having a diameter from 100 μm to 345 μm in an amount of not greater than 95 vol %, or not greater than 90 vol %, or not greater than 80 vol %, or not greater than 70 vol %, or not greater than 60 vol %, or not greater than 50 vol %, or not greater than 40 vol %, or not greater than 20 vol %, or not greater than 10 vol %, or not greater than 8 vol %.

### Embodiment 17

The monolithic porous body of any one of the preceding Embodiments, wherein the body comprises pores having a diameter of up to 2 μm in an amount of not greater than 5 vol %, or not greater than 3 vol %, or not greater than 2 vol % based on the total volume of the body.

### Embodiment 18

The monolithic porous body of any one of the preceding Embodiments, wherein the body comprises pores having a diameter greater than 345 μm in an amount of at least at least 10 vol % based on the total volume of the body, or at least 15 vol %, or at least 20 vol %, or at least 25 vol %, or at least 30 vol %, or at least 40 vol %, or at least 50 vol %.

### Embodiment 19

The monolithic porous body of any one of the preceding Embodiments, wherein the body comprises pores having a diameter greater than 345 μm in an amount not greater than 95 vol %, or not greater than 90 vol %, or not greater than 80 vol %, or not greater than 70 vol %, or not greater than 60 vol %, or not greater than 50 vol %, or not greater than 45 vol %, or not greater than 40 vol %, or not greater than 35 vol % based on the total volume of the body.

### Embodiment 20

The monolithic porous body of Embodiment 7, wherein the Sdr of the body is at least 100% and the total porosity is at least 30% based on the total volume of the body, or the Sdr is at least 150% and the total porosity is at least 50%, or the Sdr is at least 170% and the total porosity at least 70% based on the total volume of the body.

### Embodiment 21

The monolithic porous body of any one of the preceding Embodiments, wherein the monolithic ceramic body comprises Ti₄O₇.

### Embodiment 22

The monolithic porous body of any one of the preceding Embodiments, wherein the monolithic ceramic body comprises Ti₄O₇ in an amount of at least 5 wt % based on the total weight of the body, such as at least 7 wt %, at least 10 wt %, at least 12 wt %, at least 15 wt %, at least 20 wt %, at least 30 wt %, at least 40 wt %, or at least 50 wt %, or at least 70 wt %, or at least 90 wt %, or 100 wt %.

### Embodiment 23

The monolithic porous body of any one of the preceding Embodiments, wherein the monolithic body comprises Ti₄O₇ in an amount not greater than 95 wt % based on the total weight of the body, such as not greater than 90 wt %, or not greater than 80 wt %, or not greater than 70 wt %, or not greater than 60 wt %, or not greater than 50 wt %, or not greater than 30 wt %, or not greater than 25 wt %, or not greater than 20 wt %, or not greater than 15 wt %.

### Embodiment 24

The monolithic porous body of any one of Embodiments 1-20, wherein the monolithic body comprises Ti₅O₉ in an amount of at least 20 wt % based on the total weight of the body, or at least 30 wt %, or at least 50 wt %, or at least 55 wt %, or at least 60 wt %, or at least 65 wt %, or at least 70 wt %, or at least 75 wt %.

### Embodiment 25

The monolithic porous body of one of Embodiments 1-20, wherein the monolithic body comprises Ti₅O₉ in an amount of not greater than 99 wt %, or not greater than 95 wt %, or not greater than 90 wt %, or not greater than 85 wt %, or not greater than 70 wt %, or not greater than 50 wt % based on the total weight of the body.

### Embodiment 26

The monolithic porous body of any one of Embodiments 1-20, wherein the monolithic body comprises Ti₆O₁₁ in an amount of at least 1 wt % based on the total weight of the body, or at least 2 wt %, or at least 5 wt %, or at least 7 wt %, or at least 9 wt %.

### Embodiment 27

The monolithic porous body of any one of Embodiments 1-20, wherein the monolithic body comprises Ti₆O₁₁ in an amount of not greater than 20 wt % based on the total weight of the body, or not greater than 15 wt %, or not greater than 10 wt %, or not greater than 5 wt %, or not greater than 1 wt %.

### Embodiment 28

The monolithic porous body of any one of Embodiments 1-20, wherein the monolithic porous body consists essentially of Ti₄O₇.

### Embodiment 29

The monolithic porous body of any one of Embodiments 1-20, wherein the monolithic porous body consists essentially of Ti5O9.

### Embodiment 30

The monolithic ceramic body of any one of Embodiments 1-20, wherein the monolithic ceramic body consists essentially of Ti₄O₇ and Ti₅O₉.

### Embodiment 31

The monolithic porous body of any one of Embodiments 1-20, wherein the monolithic body comprises at least 10 wt % Ti₄O₇, at least 50 wt % Ti₅O₉, at least 4 wt % Ti₆O₁₁, and at least 1 wt % Ti₇O₁₃.

### Embodiment 32

The monolithic porous body of any one of the preceding Embodiments, wherein the monolithic body comprises an electric conductivity of at least 20 S/cm, or at least 25 S/cm, or at least 30 S/cm, or at least 50 S/cm, or at least 70 S/cm, or at least 100 S/cm.

### Embodiment 33

The monolithic porous body of any one of the preceding Embodiments, wherein the body is made by 3D printing, such as powder bed processes, such as binder jetting or powder bed fusion.

### Embodiment 34

The monolithic porous body of any one of the preceding Embodiments, wherein the monolithic porous body further comprises a frame structure.

### Embodiment 35

The monolithic porous body of Embodiment 34, wherein the frame structure has a lower porosity than a center region of the monolithic porous body, and the frame structure comprises the same magneli phase titanium oxide as the center region.

### Embodiment 36

The monolithic porous body of Embodiment 34, further comprising a reinforcement structure.

### Embodiment 37

The monolithic porous body of Embodiment 36, wherein the reinforcement structure divides the center region in a plurality of porous body sections.

### Embodiment 38

The monolithic porous body of Embodiment 36, wherein the reinforcement structure has a lower porosity than the porous body sections, and the reinforcement structure comprises the same magneli phase titanium oxide as the porous body sections.

### Embodiments 39

The monolithic porous body of any one of the preceding embodiments, wherein the monolithic body comprises a flexural strength of at least 0.05 MPa, or at least 0.1 MPa, or at least 0.5 MPa, or at least 1 MPa, or at least 2 MPa, or at least 5 MPa, or at least 10 MPa, or at least 15 MPa, or at least 20 MPa.

### Embodiment 40

A method of making a monolithic porous body, comprising providing magneli phase titanium oxide particles comprise a multi-modal particle distribution; 3D-printing a green body using the magneli-phase titanium oxide particles and a binder; debinding and sintering the green body to form a monolithic porous body comprising magneli phase titanium oxide, wherein the monolithic porous body has a developed interfacial area ratio Sdr of at least 60%, the Sdr being measured according to ISO25178-2:2012.

### Embodiment 41

The method of Embodiment 40, wherein the magneli-phase titanium oxide particles comprise a bi-modal particles distribution.

### Embodiment 42

The method of Embodiments 40 or 41, wherein the magneli-phase titanium oxide particles comprise a first plurality of particles having an average particles size (D50) of at least 1 μm and not greater than 10 μm, and a second plurality of particles having an average particle size (D50) of at least 20 μm and not greater than 50 μm.

### Embodiment 43

The method of Embodiment 42, wherein a wt % ratio of an amount of the first plurality of particles to an amount of the second plurality of particles ranges from 1:0.1 to 1:10.

### Embodiment 44

The method of Embodiment 42, wherein the wt % ratio of the first plurality of particles to an amount of the second plurality of particles is 1:0.3, or not greater than 1:0.5, or not greater than 1:1, or not greater than 1:2, such as not greater than 1:3, or not greater than 1:4, or not greater than 1:5, or not greater than 1:6, or not greater than 1:7, or not greater than 1:8, or not greater than 1:9, or not greater than 1:10.

### Embodiment 45

The method of any one of Embodiments 40 to 44, wherein sintering is conducted up to a maximum sintering temperature of at least 1300° C., or at least 1350° C., or at least 1400° C., or at least 1450° C., or at least 1500° C.

### Embodiment 46

The method of any one of Embodiments 40 to 45, wherein the monolithic porous body comprises a total porosity of at least 25% based on the total volume of the body, or at least 30 vol %, or at least 35 vol %, or at least 40 vol %, or at least 45 vol %, or at least 50 vol %, or at least 60 vol %, or at least 75 vol %, or at least 80 vol %, or at least 85 vol %, or at least 90 vol %.

### Embodiment 47

The method of any one of Embodiments 40 to 46, wherein the body comprises a total porosity of not greater than 99 vol %, or not greater than 95 vol %, or not greater than 90 vol % based on the total volume of the body, or not greater than 85 vol %, or not greater than 75 vol %, or not greater than 70 vol %, or not greater than 60 vol %.

### Embodiment 48

The method of any one of Embodiments 40 to 47, wherein the body comprises pores having a diameter from 2 μm to 10 μm in an amount of at least 15 vol % based on the total volume of the body, such as at least 18 vol %, at least 20 vol %, at least 25 vol %, or at least 30 vol %.

### Embodiment 49

The method of any one of Embodiments 40 to 48, wherein the body comprises pores having a diameter from 10 μm to 20 μm in an amount of at least 2 vol %, or at least 3 vol %, or at least 4 vol %, or at least 5 vol % based on the total volume of the body.

### Embodiment 50

The method of any one of Embodiments 40 to 49, wherein the body comprises pores having a diameter from 20 μm to 100 μm in an amount of at least 3 vol %, or at least 4 vol %, or at least 5 vol %, or at least 6 vol %, or at least 10 vol %, or at least 15 vol %, or at least 20 vol % based on the total volume of the body.

### Embodiment 51

The method of any one of Embodiments 40 to 50, wherein the body comprises pores having a diameter from 100 μm to 345 μm in an amount of at least 4 vol %, or at least 5 vol %, or at least 6 vol %, or at least 7 vol %, or at least 10 vol %, or at least 15 vol %, or at least 20 vol %, based on the total volume of the body.

### Embodiment 52

The method of any one of Embodiments 40 to 51, wherein the body comprises pores having a diameter of up to 2 μm in an amount of not greater than 5 vol %, or not greater than 3 vol %, or not greater than 2 vol % based on the total volume of the body.

### Embodiment 53

A method of purifying polluted water, comprising: conducting electrochemical deposition of an organic pollutant contained in the polluted water, wherein the electrochemical deposition is conducted in electrolytic cell including the monolithic ceramic body of Embodiment 1 as an anode.

### EXAMPLES

The following non-limiting examples illustrate the present invention.

### Example 1

Producing of monolithic porous body including magneli-phase titanium oxide.

A curable composition was prepared using a magneli-phase titanium oxide powder material containing 40 wt % Ti₅O₉ and 60 wt % Ti₆O₁₁ The magneli phase powder was a mixture of fine and coarse particles. The fine TiOₓ particles had an average particle size (D50) of approximately 4-6 μm, an aspect ratio of 1.66, and a roundness of 0.6, and the coarse TiOₓ particles had an average particle size (D50) of approximately 25-28 μm, an aspect ratio of 1.67 and a roundness of 0.6. The aspect ratio is the ratio of major axis length to major axis height of a particle, and the roundness is calculated as 4×area/π×(major axis length)².

The ratio of the fine TiOₓ particles to the more coarse TiOₓ particles was 20:80 for making a first body (Sample S1). A second body (Sample S2) was made from a 30:70 mixture of the fine and coarse particles.

The 3D printing was conducted by binder jetting, using the above-described powder mixture and the aqueous binder BA005 from ExOne. The printing conditions are summarized in Table 1. Sample S1 was printed using an ExOne Innovent Standard Recoater. Sample S2 was made using an ExOne Innovent Enhanced Recoater.

TABLE 1

| Parameter | Sample S1 | Sample S2 |
|---|---|---|
| Saturation (%) | 125 | 125 |
| Layer Thickness [μm] | 75 | 75 |
| Foundation Layer Count | 5 | 5 |
| Oscillator on Delay (sec) | 2 | 2 |
| Binder Set (sec) | 5 | 5 |
| Dry Time (sec) | 15 | 15 |
| Target Temperature (° C.) | 30 | 30 |
| Recoat Speed (rpm) | 10 | 17 |
| Oscillator Speed (rpm) | 2800 | — |
| Roller Speed (rpm) | 100 | 100 |
| Roller Speed (mm/s) | 2 | 3 |

The design for the three-dimensional printing was created to produce bodies with a high surface area and a high porosity with interconnected pores over a wide size range.

After the 3D-printing to form the green bodies of Samples S1 and S2, the green bodies were subjected to a heat treatment regime to remove the binder and to sinter the bodies. The heat treatment was conducted at a ramp rate of 5° C./min up to temperature of 375° C. under air, and held for one hour at 375° C. to remove the binder. Thereafter, the air was replaced with argon and the body further heated at a ramp rate of 5° C./min up to a maximum temperature of 1500° C. The temperature was held for four hours at 1500° C., and cooling was conducted at a rate of 5° C./minute.

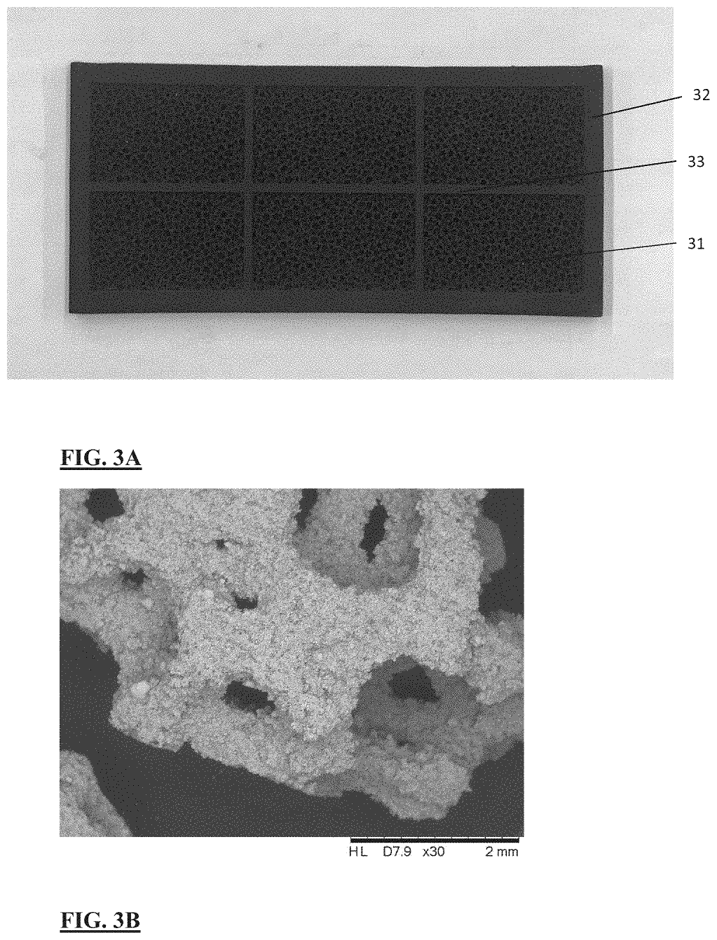

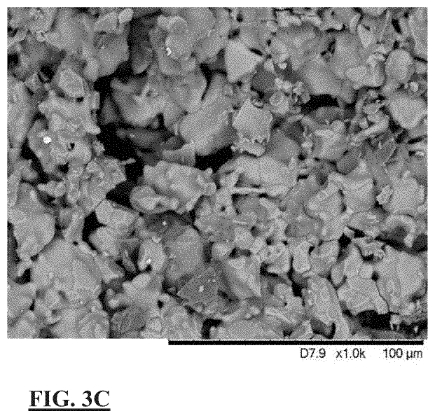

FIG. 3A shows an image of a 3D printed and high temperature sintered monolithic body of Sample 51. The monolithic body shown in FIG. 3A includes highly porous regions (31), a frame structure (32), and a reinforcement structure (33).

Table 2 gives a comparison of some of the dimensions of the monolithic body shown in FIG. 3A before and after sintering:

TABLE 2

| | Green body | Sintered body |
|---|---|---|
| Length [cm] | 14.1 | 13.4 |
| Width [cm] | 6.5 | 6.2 |
| Height [cm] | 0.5 | 0.5 |
| Width of frame [cm] | 0.5 | 0.5 |
| Width of | 0.2 | 0.2 |
| reinforcement | | |
| structure [cm] | | |
| Volume of full body | 45.8 | 40.5 |
| [cm³] | | |

FIG. 3B includes an image with 30 times magnification of a portion of a highly porous region (31) of the body shown in FIG. 3A, and FIG. 3C shows a similar highly porous region, but with 1000 times magnification.

It can be seen, especially in FIGS. 3B and 3C, that the body of Sample S1 had a high surface area and a large variety of pores of different sizes.

It was further found through empirical studies that the use of a monomodal distribution of TiOx particles did not produce bodies having the features of embodiments herein. Specifically, is was found that monomodal distributions of fine particles may not flow as needed, and thereby making a proper formation of a green body difficult. In other instances, a monomodal distribution of only coarse particles can make proper sintering difficult and the obtained bodies do not have a desired strength. Selecting a ratio of 10:90 between fine particles to coarse particles also failed to form a body having a desired flexural strength as described in embodiments herein.

### Comparative Example 1

Comparative porous bodies were produced via a replica method, wherein polyurethane foams with varying pore structure were impregnated with a slurry containing TiOx particles with an average particle size of 0.8 μm in an amount of 77.8 wt %. The slurry composition further contained 8.9 wt % water, 12.6 wt % aqueous polyvinyl alcohol (PVA) (having a concentration of 7.5 wt % PVA), and 0.7 wt % TiO2 (P25 from Evonik).

After impregnation of the polyurethane foam, the impregnated foam was dried at room temperature for at least 24 hours, and thereafter subjected to a heat treatment regime to remove the binder and the polyurethane core structure, and to conduct sintering of the TiOx particles. The heat treatment regime for debinding and sintering was conducted under argon at a ramp rate of 50° C./hour, up to 1450° C., held for two hours at 1450° C., followed by free cooling.

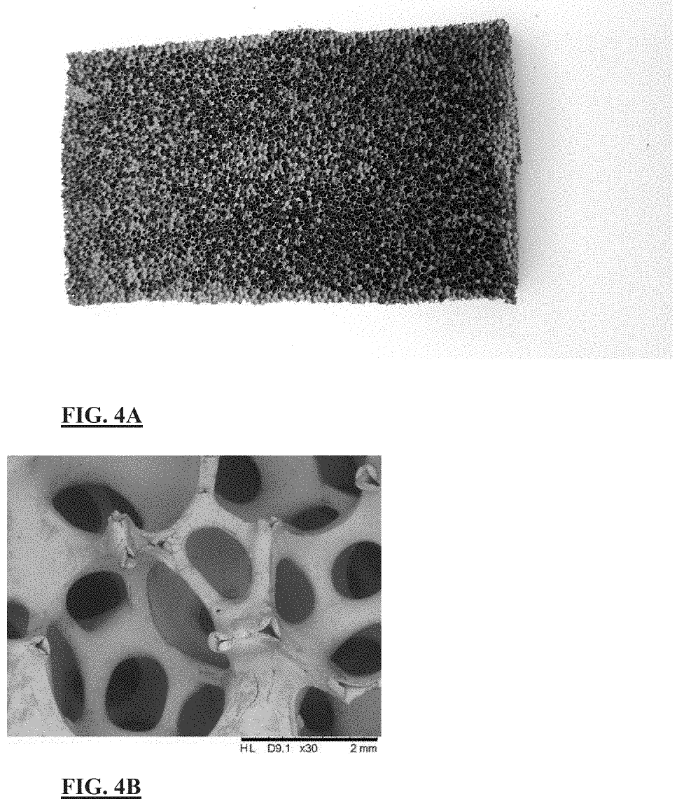

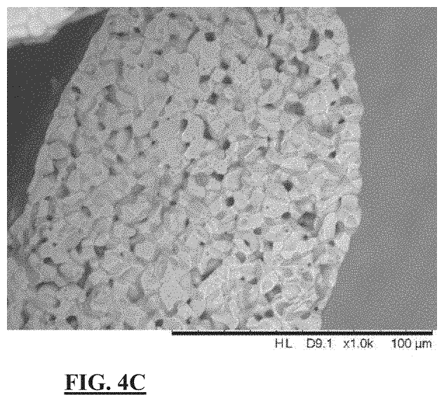

According to the replica method, a comparative TiOx material was prepared with about the same macro-porosity (porosity generated by pores >345 μm) as bodies S1 and S2, which is hereinafter called comparative body C1. An image of comparative body C1 can be seen in FIG. 4A. FIG. 4B shows a portion of body C1 with 30 times magnification, and FIG. 4C shows a portion of body C1 with 1000 times magnification.

### Comparative Example 2

A comparative body C2 is printed via binder jetting having the same macro-porosity of the bodies of Example 1, such as 13 pores per inch (ppi), but a lower Sdr. The comparative body is formed by binder jetting layers with a thickness of 50 microns and using a ceramic powder with a bi-modal particle size distribution, wherein the maximum particle size of the powder was not greater than 20 microns and the minimum particle size at least 1 micron. After high temperature sintering, a body is obtained having an Sdr below 60%.

Measurement of Porosities

Tables 3 and 4 include a summary of the porosity properties of samples S1 and S2 and of comparative sample C1. The volume percent amount of pores up to a size of 345 μm was measured via mercury porosimetry with a Micromeritics AotoPore IV 9500 machine (see Table 3).

Large pores that were not analyzed via the mercury porosimetry analysis were quantified by determining the “ppi value.” The ppi value (pores per inches) was measured by analyzing magnified images of the body and counting the amount of pores over the length distance of one inch. The ppi value of a body sample can be considered herein also as a property describing the macro-pore structure of the body, and addresses pores with a diameter from 250 μm up to about 2000 μm.

Furthermore, the density and total porosity was calculated based on the software design of the body samples for the 3D printer, subtracting from the total volume of the body the volume occupied by the printed body skeleton, and using the density of 4.33 g/cm³ of the solid body material obtained by Helium pycnometry.

The analysis of the pore structure showed that the samples S1 and S2 had a similar macro-pore structure (ppi) as comparative sample C1, but the pore volume contributed especially by pores smaller than 20 μm was in the comparative body C1 much lower (see Tables 3 and 4).

TABLE 3

| | 0 to 2 μm | 2-10 μm | 10-20 μm | 20-100 μm | 100-345 μm |
|---|---|---|---|---|---|
| Sample | [vol %] | [vol %] | [vol %] | [vol %] | [vol %] |
| S1 | 0.8 | 31.4 | 3.7 | 4.6 | 5.5 |
| S2 | 0.3 | 20.8 | 5.5 | 7.5 | 7.9 |
| C1 | 2.4 | 4.3 | 1.1 | 6.1 | 3.2 |

TABLE 4

| | Porosity up | Pores | | | Total |
|---|---|---|---|---|---|
| | to 345 μm | per inch | Porosity > | Density | Porosity |
| Sample | [vol %] | [ppi] | 345 μm [vol %] | [g/cm³] | [vol %] |
| S1 | 45.9 | 13 | 38.5 | 0.77 | 84.3 |
| S2 | 41.9 | 13 | 42.4 | 0.77 | 84.3 |
| C1 | 17.1 | 13 | | | |

Measurement of Sdr

The surface structure of bodies S1 and S2 of Examples 1 and 2 was characterized by measuring the developed interfacial area ratio Sdr according to ISO 25178-2:2012. The developed interfacial area ratio Sdr expresses the percentage rate of an increase in a surface area A₁ that is related to the surface texture in comparison to a projected area A₀, wherein A₀ corresponds to an ideal plane underneath the measured surface texture. An illustration of the relation of surface area A₁ to projected area A₀ is shown in FIG. 5. The Sdr measurements were conducted with an Olympus LEXT OLS5000 laser confocal microscope. The analyzed surface area was 257×257 μm, at a 50 times magnification, with a filter cylinder. Four measurements per sample were conducted at different locations and an average Sdr value was calculated according to equation

$$S d r = \frac{1}{A} [ \int {\int }_{A} ( \sqrt{[ 1 + {( \frac{\partial z ( x , y )}{\partial x} )}^{2} + {( \frac{δ z ( x , y )}{δ y} )}^{2} ]} - 1 ) d x dy ] .$$

The Sdr can be also expressed by the formula Sdr=[(A₁/A₀)−1]×100(%).

The Sdr values of Samples S1 and S2 of Examples 1 and 2 are summarized in Table 3, and compared with the Sdr values of the comparative sample C1.

The Sdr values summarized in Table 5 demonstrate that the 3D printed bodies S1 and S2 have much higher Sdr values (corresponding to a higher surface area A1) than the comparative example C1.

TABLE 5

| | | | A₁ [μm²] | Sdr [%] |
|---|---|---|---|---|
| Sample | Sdr[%] | A₁ [μm²] | St Dev | St Dev |
| S1 | 183.3 | 187899.0 | 12262.8 | 18.5 |
| S2 | 180.7 | 186130.5 | 11416.1 | 17.2 |
| C1 | 29.8 | 86102.0 | 11460.9 | 17.3 |

For the analysis of the Sdr and the porosity described above, only the highly porous regions (31) were analyzed. The Sdr of the frame regions (32) was separately measured. It could be observed that the Sdr of the frame regions (32) of the 3D printed monolithic bodies (S1 and S2) were in a similar range as the Sdr of the highly porous regions (31). Accordingly, the frame regions (32) had in certain aspects a similar micro-porous structure as the highly porous regions (31), but no macro-pores.

Analysis of TiOₓ Magneli Phases Contained in the Body Materials

Sample S1 and comparative samples C1 were analyzed via XRD measurement for the type and percentage of magneli phases contained in the body materials.

Table 6 shows a summary of the of the measured magneli phases contained in the S1 and C1 bodies in comparison to the starting powder mixture. It can be seen for both S1 and C1 that the forming and sintering of the bodies caused some changes in the phase compositions, specifically a larger increase in the Ti₅O₉ phase and Ti₄O₇ phase, and a decrease in the Ti₆O₁₁ phase and Ti₇O₁₃ phase.

TABLE 6

| | Ti₄O₇ [%] | Ti₅O₉ [%] | Ti₆O₁₁ [%] | Ti₇O₁₃ [%] | X value of combination |
|---|---|---|---|---|---|
| Sample | (X = 1.750) | (X = 1.800) | (X = 1.833) | (X = 1.857) | X = m/n in TiₙOₘ |
| TiOx | 8 | 27 | 56 | 10 | 1.82 |
| Powder | | | | | |
| S1 | 13 | 75 | 9 | 3 | 1.799 |
| C1 | 20 | 78 | 0 | 3 | 1.792 |

Testing of Water Pollutant Degradation

For testing the efficiency of Samples S1 and S2 as anode material in an electrolytic cell with regard water pollutant degradation, the degradation of acetaminophen as an example pollutant was investigated.

The electrolytic cell was designed that the anode material was a rectangular plate of the porous TiOx body with a size of 63 mm×33 mm×5 mm, which was positioned in the center of two cathodes made of titanium mesh (titanium grade 1, R3×1.9-0.5×0.6 calandre from ITALFIM) having the same size as the anode, with a gap of 15 mm between anode and each cathode.

The fluid for conducting the electrolysis had a total volume of 500 ml, including 0.08 g acetaminophen (0.16 kg/m³), 3.55 g Na₂SO₄ as electrolyte (7.1 kg/m³), and distilled water. The electrolysis was conducted at a current density of 5 mA/cm² (50 A/m²) under magnetic stirring of the fluid and under recirculating the fluid with a pump, such that the full fluid amount was completely recirculated every 90 seconds, while the electrodes were always covered by the fluid.

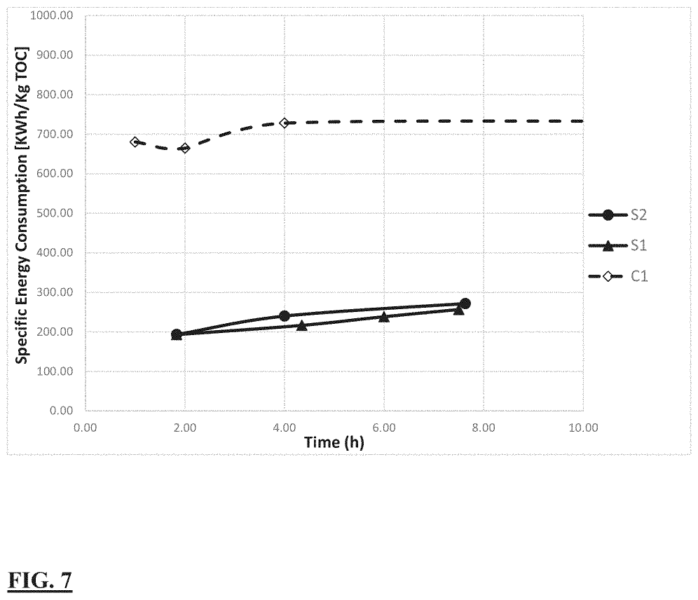

It could be surprisingly observed that Samples S1 and S2 had a much higher degradation efficiency than comparative Sample C1 although the comparative body had a similar macro-porosity as Samples S1 and S2, see FIG. 6 and the summary in Table 7.

TABLE 7

| | Acetaminophen Degradation [%] | | |
|---|---|---|---|
| Hours | S1 | S2 | C1 |
| 1 | 16.0 | 14 | 3.5 |
| 2 | 22.6 | 23 | 7.3 |
| 4 | 48.0 | 47 | 13.6 |

The acetaminophen degradation was further evaluated with regard to the specific energy consumption needed for degrading 1 kg total organic carbon (TOC) of the acetaminophen with ongoing electrolysis time. As illustrated in FIG. 7, if Samples S1 and S2 were used as anode materials, the required specific energy per kg TOC elimination was much lower compared to comparative sample C1 used as anode material: The electrolysis with anode material of Samples S1 and S2 required only about one third of the specific energy consumption than comparative sample C1 between 1 and 8 hours electrolysis time.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. A monolithic porous body comprising magneli phase titanium oxide and a developed interfacial area ratio Sdr of at least 60%, the Sdr being measured according to ISO25178-2:2012.

2. The monolithic porous body of claim 1, wherein the body comprises a water pollutant degradation of at least 25%.

3. The monolithic porous body of claim 2, wherein a specific energy consumption for conducting the water pollutant degradation is not greater than 600 kWh/kg TOC between 1 and 10 hours.

4. The monolithic porous body of claim 1, wherein the body comprises a total porosity of at least 25% based on the total volume of the body.

5. The monolithic porous body of claim 1, wherein the body comprises pores having a diameter from 2 μm to 10 μm in an amount of at least 15 vol %.

6. The monolithic porous body of claim 1, wherein the body comprises pores having a diameter greater than 345 μm in an amount of at least at least at least 30 vol % based on the total volume of the body.

7. The monolithic porous body of claim 4, wherein the Sdr of the body is at least 150% and the total porosity is at least 50% based on the total volume of the body.

8. The monolithic porous body of claim 1, wherein the body comprises Ti₄O₇.

9. The monolithic porous body of claim 1, wherein the body comprises an electric conductivity of at least 20 S/cm.

10. The monolithic porous body of claim 1, wherein the body further comprises a frame structure, and wherein the frame structure has a lower porosity than a center region of the monolithic porous body, and the frame structure comprises the same magneli phase titanium oxide as the center region.

11. The monolithic porous body of claim 10, further comprising a reinforcement structure.

12. A method of making a monolithic porous body, comprising providing magneli phase titanium oxide particles comprise a multi-modal particles distribution;
3D-printing a green body using the magneli-phase titanium oxide particles and a binder;
debinding and sintering the green body to form a monolithic porous body comprising magneli phase titanium oxide,
wherein the monolithic porous body has a developed interfacial area ratio Sdr of at least 60%, the Sdr being measured according to ISO25178-2:2012.

13. The method of claim 12, wherein the magneli-phase titanium oxide particles comprise a bi-modal particles distribution.

14. The method of claim 13, wherein the magneli-phase titanium oxide particles comprise a first plurality of particles having an average particles size (D50) of at least 1 μm and not greater than 10 μm, and a second plurality of particles having an average particle size (D50) of at least 20 μm and not greater than 50 μm.

15. The method of claim 14, wherein a wt % ratio of an amount of the first plurality of particles to an amount of the second plurality of particles ranges from 1:0.1 to 1:10.

16. The method of claim 12, wherein sintering is conducted up to a maximum sintering temperature of at least 1300° C.

17. The method of claim 12, wherein the body comprises a total porosity of at least 25% based on the total volume of the body.

18. The method of claim 12, wherein the body comprises pores having a diameter from 2 μm to 10 μm in an amount of at least 15 vol %.

19. The method of claim 12, wherein the body comprises pores having a diameter greater than 345 μm in an amount of at least at least at least 30 vol % based on the total volume of the body.

20. A method of purifying polluted water, comprising: conducting an electrochemical deposition of an organic pollutant contained in the polluted water, wherein the electrochemical deposition is conducted in an electrolytic cell including the monolithic ceramic body of claim 1 as an anode.
